(19) United States
(12) Patent Application Publication
(10) Pub. No.: US 2022/0400687 A1
(43) Pub. Date: Dec. 22, 2022

(54) USE OF SOLUTIONS OF CANNABINOIDS FOR IMPROVING CANNABINOID PRODUCTION IN CANNABIS PLANTS TREATED THEREWITH

(71) Applicant: Fractal Growth LLC, Loveland, CO (US)

(72) Inventors: Michael J. Walsh, Loveland, CO (US); Brady S. Price, Loveland, CO (US)

(73) Assignee: Fractal Growth LLC, Loveland, CO (US)

(21) Appl. No.: 17/750,102

(22) Filed: May 20, 2022

Related U.S. Application Data
(60) Provisional application No. 63/209,373, filed on Jun. 10, 2021.

(51) Int. Cl. A01N 65/08; B01D 11/02

(52) U.S. Cl. CPC A01N 65/08; B01D 11/0203; B01D 11/0292

(57) ABSTRACT

Methods for increasing cannabinoid production in growing cannabis plants, and for lowering the hydrophobicity of soil are described. Foliar application of compositions comprising cannabinoids extracted from Cannabis sativa hemp to the growing plants and/or drenching the soil surrounding the growing cannabis plants therewith have been demonstrated to produce significant changes in cannabinoid production, thereby generating an increase in the marketable portion of the crop. Additionally, application of these compositions to the soil reduces soil hydrophobicity.

### CROSS-REFERENCE TO RELATED APPLICATIONS

The present application claims the benefit of U.S. Provisional Patent Application No. 63/209,373 for “Use of Solutions of Cannabinoids for Improving Cannabinoid Production in Cannabinoid Plants Treated Therewith” by Michael J. Walsh and Brady S. Price, which was filed on Jun. 10, 2021, the entire content of which application is hereby specifically incorporated by reference herein for all that it discloses and teaches.

### BACKGROUND

Improving crop production is a desired result of treating plants and/or soil with beneficial substances applied in appropriate amounts and at designated treatment intervals. Applied liquids may be absorbed through the leaves or through the roots of the treated plants or through both processes.

### SUMMARY

In accordance with the purposes of the present invention, as embodied and broadly described herein, an embodiment of the method for increasing cannabinoid production in growing Cannabis sativa plants, hereof includes: extracting oil containing cannabinoids from Cannabis sativa hemp; forming a solution of the extracted oil in a mixture of ethanol and water having a chosen concentration of the extracted oil; and applying the solution to said growing Cannabis plants at chosen times during plant growth.

In another aspect of the present invention and in accordance with its purposes, as embodied and broadly described herein, an embodiment of the method for reducing the hydrophobicity of soil, hereof includes: extracting oil containing cannabinoids from Cannabis sativa hemp; forming a solution of the extracted oil in a mixture of ethanol and water having a chosen concentration of the extracted oil; and applying the solution to said soil.

Benefits and advantages of the present invention include, but are not limited to, increasing cannabinoid production in growing cannabis plants by applying compositions comprising cannabinoids extracted from Cannabis sativa hemp to the growing plants and/or to the surrounding soil, thereby generating an increase in the marketable portion of the crop. Additionally, application of these compositions to the soil reduces soil hydrophobicity.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1A is a graph illustrating the foliar application of the GREASE™ compositions in mL/Gallon as a function of week of growing season, while FIG. 1B is a graph showing the drench application of the GREASE™ compositions in mL/Gallon as a function of week of growing season.

FIG. 2A is a graph of CBDA concentration in arbitrary units illustrating the effect of GREASE™ Gold Oil on CBDA levels in Cannabis sativa for two trials, where the left feature for both trials is the CBDA level control, while the right feature represents the treated plants; FIG. 2B is a graph of CBDA concentration in arbitrary units illustrating, from left to right, the effect of GREASE™ Gold Oil, GREASE™ Green Oil, GREASE™ Purple Oil, GREASE™ Yellow Oil, and GREASE™ Amber Oil, on CBDA levels in Cannabis sativa, where the left feature for each lot is the CBDA level control, while the right feature represents the treated plants; and FIG. 2C is a graph of CBDA concentration in arbitrary units illustrating, from left to right, the effect of GREASE™ Gold Oil, GREASE™ Green Oil, GREASE™ Purple Oil, GREASE™ Yellow Oil, and GREASE™ Amber Oil, on CBDA levels in Cannabis sativa, where the left feature for each lot is the CBDA level control, while the right feature represents the treated plants, where these experiments were performed at a different time and at a different location.

FIG. 3 is a graph of the average soil hydrophobicity in units of pour through time in seconds, for GREASE™, ethanol, and a control.

### DETAILED DESCRIPTION

Briefly, embodiments of the present invention include the use of compositions prepared from Cannabis plants, hereinafter called GREASE™, when solubilized and sprayed onto the roots of growing Cannabis plants, or onto the plants themselves for increasing cannabinoid or resin content of the growing Cannabis plants. GREASE™ is a Trademark of Fractal Growth LLC. As is described in detail below, five GREASE™ compositions (Gold, Green, Yellow, Purple, and Amber) were prepared and utilized in the practice of the present invention.

High Performance Liquid Chromatography with DA (diode array) detection (HPLC-UV) was used to analyze the five GREASE™ compositions used for plant growth studies for cannabinoids, and the results are shown in TABLE 1.

TABLE 1

| GREASE ™ | CBD | CBC | CBDA |
|---|---|---|---|
| Gold | 0.33%; 3.33 mg/g | 0.01%; 0.13 mg/g | ND |
| Green | 0.29%; 2.89 mg/g | 0.02%; 0.16 mg/g | 0.01%; 0.10 mg/g |
| Purple | 0.41%; 4.13 mg/g | ND | ND |
| Amber | 0.32%; 3.23 mg/g | 0.02%; 0.17 mg/g | ND |
| Yellow | 0.18%; 1.77 mg/g | ND | 0.15%; 1.50 mg/g |

where, CBD is Cannabidiol; CBC is Cannabichromene; CBDA is Cannabidiolic acid (acid form of CBD); and ND means None Detected.

The five GREASE™ compositions set forth in TABLE 1 were prepared as follows:

A. GREASE™ Gold Oil Extraction:

1. Extraction from whole plant Cannabis sativa hemp that is harvested and dried, with plants being hung upside down at ambient temperature, such that 70%-85% by weight of water is evaporated;

2. Place dried hemp in 100-micron nylon Filter Bags for extraction;

3. Decarboxylize hemp at 200-260 F for between 2 and 4 h;

4. Extract filled filter bags using supercritical carbon dioxide for 30 min.;

5. Repeat 1-10 times;

6. Recover CO₂; and

7. Remove the oil from the collection vessel.

B. GREASE™ Green Oil Extraction:
1. Extraction from whole plant Cannabis sativa hemp that is harvested and dried;
2. Place in freezer at between −10° F. and 10° F. for 24 h;
3. Fill Extraction vessel with frozen hemp;
4. Cover frozen hemp with cold ethanol;
5. Contact frozen hemp with cold ethanol for between 1 and 45 min.;
6. Filter ethanol through 100-micron screen into a collection vessel;
7. Press the remaining material in a screw press, and place the extracted liquid in the collection vessel;
8. Heat collection vessel to between 200° F. and 230° F. for between 8 h and 9 h to remove the ethanol from the extracted oil(s) with occurring decarboxylation; and
9. Remove the extracted oil(s) from the extraction vessel.

C. GREASE™ Yellow Oil Extraction:
1. Extraction from whole plant Cannabis sativa hemp that is harvested and frozen at between −10° within 48 h of its freshly harvested state;
2. Fill 100-micron nylon filter bags with frozen hemp for extraction;
3. Place filter bags in extraction vessels;
4. Cover filter bags with liquid propane (−104° C.) for 4 min.;
5. Transfer liquid propane into collection vessel;
6. Heat collection vessel to between 120° F. and 200° F. using hot water;
7. Recover propane under vacuum during heating of collection vessel; and
8. Purge remaining propane solvent in vacuum oven (−24 in. of Hg) at between 80° F. and 120° F. for 120 h.
Only naturally occurring cannabinoids were utilized, there being no decarboxylation for this oil.

D. GREASE™ Purple Oil Extraction:
1. Extraction from whole plant Cannabis sativa hemp that is harvested and dried;
2. Fill 100-micron nylon filter bags with dried hemp;
3. Place filter bags in extraction vessels;
4. Cover filter bags with liquid propane for 4 min.;
5. Transfer liquid propane into collection vessel;
6. Heat collection vessel to between 120 and 200 F using hot water;
7. Recover propane under vacuum during heating of collection vessel;
8. Repressurize collection vessel;
9. Extract crude oil from collection vessel;
10. Heat extracted crude oil to between 70 and 100 deg. for between 10 and 20 min.;
11. Add ethanol to the crude oil in a 4/1 ratio by volume;
12. Place in freezer at between 10° F. and 10° F. for 24 h, where separation of fats therein occurs;
13. Filter the winterized crude oil through 2-micron filter in a Buchner funnel under vacuum;
14. Place the filtered and winterized crude oil in a rotary evaporator to recover the ethanol solvent (Ethanol will evaporate at between 154° F. and 167° F. and a vacuum of about 0.6 in. of Hg.);
15. Remove the oil from the rotary evaporator;
16. Decarboxylate the oil at 212° F. for between 8 and 9 h;
17. Heat the decarboxylated crude oil with stirring to 167° F.;
18. Distill the decarboxylated crude oil into a cold trap at about 15° F.;
19. Slowly raise the oil temperature to 120° F.;
20. Heat cold trap to 167° F. C, and then slowly raise the temperature to 428° F.;
21. Keep the oil at 428° F. for between 6 h and 10 h;
22. Cool collection vessel to 248° F. before opening; and
23. Purge oil collected under vacuum at −24 in. of Hg at between 80° F. and 120° F. for between 50 h and 120 h.
E. GREASE™ Amber Oil Extraction:
1. Extraction from whole plant Cannabis sativa hemp that is harvested and dried;
2. Fill 100-micron nylon filter bags with dried hemp;
3. Place filter bags in extraction vessels;
4. Cover filter bags with liquid propane for 4 min.;
5. Transfer liquid propane into collection vessel;
6. Heat collection vessel to between 120° F. and 200° F. using hot water;
7. Recover propane under vacuum during heating of collection vessel;
8. Repressurize collection vessel;
9. Extract crude oil from collection vessel;
10. Decarboxylate crude oil between 100° F. and 230° F. for between 1 h and 9 h; and
11. Purge decarboxylated oil of residual propane solvent under vacuum (−24 in. Hg) at between 80° F. and 120° F. for 120 h.

Extracted oils may be stored at 40° F., where degradation has been observed to be slow. Solubilization of the oils prepared in extractions A-E above is achieved as follows:

(a) Add between 0.1% and 1% of the extracted oil to 100% ethanol by weight with stirring;

(b) Heat the resulting mixture to between 100° F. and 400 F; and

(c) Dilute the heated mixture with water (H₂O) obtained by reverse osmosis, to about 40% by weight of the heated mixture, whereby the cannabinoid active ingredient is between 0.1% and 1% by weight of the resulting mixture. In the resin production results described below, 0.3% was used.

The color designations of the oils produced in extractions A-E derive from the colors observed in step (c) above: A: Gold; B: Green; C: Yellow; D: Purple; and E: Amber. These solutions were used to form the beneficial plant amendments and soil conditioners utilized with the Cannabis plants as described below.

Reference will now be made in detail to the present embodiments of the invention, examples of which are illustrated in the accompanying drawings. It will be understood that the FIGURES are presented for the purpose of describing particular embodiments of the invention and are not intended to limit the invention thereto.

I. Effect of Grease™ Compositions on Resin Production of Cannabis Plants:

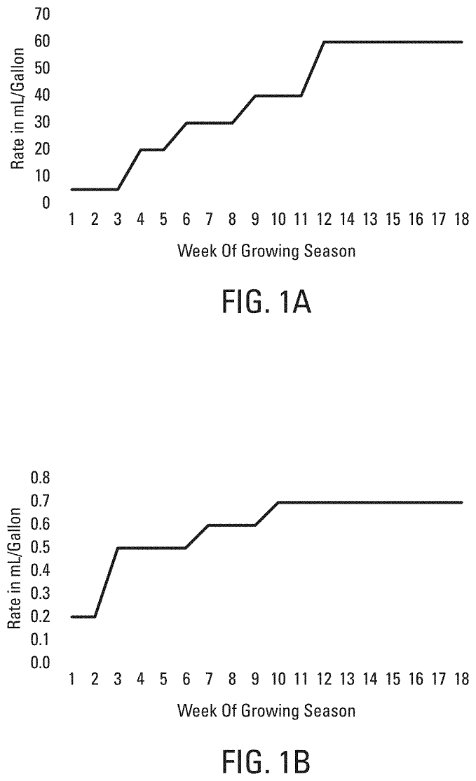

Potency testing was conducted on homogenized plant samples from treated and control plants from the same parent stock. Four varieties of cannabis plants were used: hybrid, hemp, indica, and sativa. Since these phenotypes have the same genus and species, differing in morphological characteristics, such as leaf shape and growth rate, similar resin production results were expected, and the results were therefore averaged. GREASE™ compositions were applied by foliar spraying until runoff for leaf absorption, and/or drenching plants and the surrounding soil for root absorption, at designated treatment intervals. FIG. 1A is a graph illustrating the foliar application of the GREASE™ compositions in mL/Gallon as a function of week of growing season, while FIG. 1B is a graph showing the drench application of the GREASE™ compositions in mL/Gallon as a function of week of growing season. The foliar spray was applied to the plants until runoff, with one row of plants being treated at a time using a backpack sprayer to avoid overspray.

When collecting the data for cannabinoid potency a protocol for taking an accurate, but randomized, pattern for flower sampling utilized by the Colorado Department of Agriculture for analyzing a hemp crop for potency, was followed (Colorado State Hemp Management Plan 7 CFR § 990.3(a)(2)(ii)). At the end of each lot, a random number generator was used to label them in an official manner for testing. All samples were tested using high performance liquid chromatography (HPLC).

As stated, the constituent compounds of GREASE™ include cannabinoids such as cannabidiolic acid (CBDA), cannabidiol (CBD), cannabichromene (CBC), cannabigerol (CBG), and others. Therefore, the application and assimilation of these compounds into the plant by spraying or by plant up-take from the soil is expected to increase resin, which is the part of the plant that directly correlates to potency. It is believed by the present inventors that these species increase cannabinoids since those compounds are bioavailable in the production of more cannabinoids through lipid channels and other pathways. Resin is increased because cannabinoids, when linked together, form a resinous compound that is noticeable to the eye, and is detectable when sampled from plant treatments. A visible increasing change in the resin levels, and an increased light refraction from the glandular trichomes was observed after the application of GREASE™ when compared to control plants.

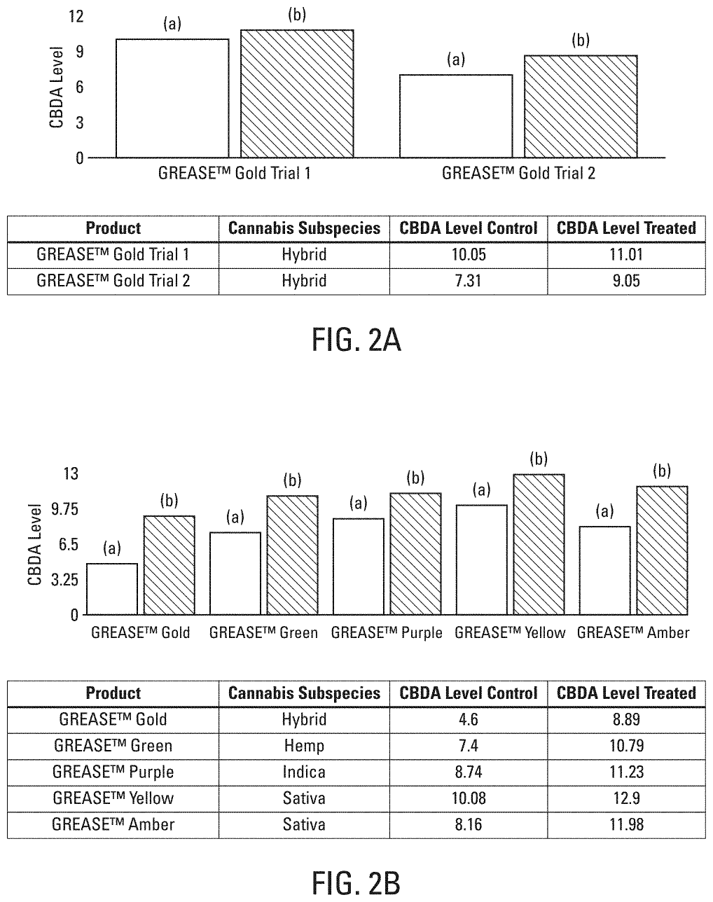

Three controlled plant treatments were performed. The first, a Certificate of Authenticity (COA) indoor trial, was performed in order to eliminate variables. cannabidiolic acid was the cannabinoid chosen to be analyzed, because of its common laboratory testing. Plant content of other cannabinoids was also examined, but CBDA content was used as a common denominator. A first plant treatment was conducted using GREASE™ Gold Oil with three hundred plants as a control, and three hundred plants were treated with GREASE™ Gold Oil for two trials. FIG. 2A is a graph of CBDA concentration in arbitrary units illustrating the effect of GREASE™ Gold Oil on CBDA levels in Cannabis sativa for Trial 1, on the left, and Trial 2, on the right. The left feature (a) for both trials is the CBDA level control, while the right feature (b) represents the treated plants. For Trial 1, CBDA level for the control was 10.05, and that for Trial 2 was 7.31, versus 11.01 and 9.05 for the treated hybrid Cannabis Subspecies, respectively. There was a 13% average increase in specific cannabinoids over the same time period. As stated, all plants were hemp varieties.

The second set of plant treatments was conducted in the field using drip irrigation with rows spaced 40 in. apart. Seven, 400 feet long rows comprised each lot, with plants at 48 in. centers. The drip system allowed for the zones to be separated, and the GREASE™ compositions were applied independently for each of the five trials. FIG. 2B is a graph of CBDA concentration or level, in arbitrary units, illustrating, from left to right, the effect of GREASE™ Gold Oil, GREASE™ Green Oil, GREASE™ Purple Oil, GREASE™ Yellow Oil, and GREASE™ Amber Oil, on CBDA levels in Cannabis sativa. The left feature (a) for each trial is the CBDA level control, while the right feature (b) represents the treated plants. The CBDA levels for the controls were 4.6, 7.4, 8.74, 10.08, and 8.16, versus 8.89, 10.79, 11.23, 12.9, and 11.98, for the treated hybrid Cannabis Subspecies, respectively. These results show that plants treated with GREASE™ compositions displayed an average 3.36% increase in specific cannabinoid production within the same time period. Since the treated plants averaged 11.16% of specific cannabinoids, a 3.36% average increase accounts for an average 30% increase in the overall specific cannabinoid content. This 30% average increase in specific cannabinoids will functionally increase resin production in the plant.

The plant treatments were repeated in another location. FIG. 2C is a graph of CBDA concentration, in arbitrary units, illustrating, from left to right, the effect of GREASE™ Gold Oil, GREASE™ Green Oil, GREASE™ Purple Oil, GREASE™ Yellow Oil, and GREASE™ Amber Oil, on CBDA levels in Cannabis sativa. The left feature (a) for each trial is the CBDA level control, while the right feature (b) represents the treated plants. The CBDA levels for the controls were 7.24, 10.1, 5.3, 8.3, and 0.32, versus 11.04, 18.49, 7.4, 8.6, and 1.17 for the treated hybrid Cannabis Subspecies, respectively. The results of this third set of plant treatments showed that plants treated with GREASE™ compositions displayed an average 3.09% increase in specific cannabinoid production within the same time period. Since the treated plants averaged 9.34% of specific cannabinoids, a 3.09% average increase accounts for an average 33% increase in the overall specific cannabinoid content. This 33% result when averaged with the 30% result from the second plant treatments yields an average of averages of 31.5% increase in CBDA.

TABLE 2 is a summary of the results of the three sets of plant treatments,

TABLE 2

| | | | | | Avg. % |
|---|---|---|---|---|---|
| | Control | Treated | % | Percentage | Change of |
| Experiment | Average | Average | Difference | Change | Replicate |
| 1 | 8.68 | 10.03 | 1.35 | 13% | |
| 2 | 7.796 | 11.158 | 3.362 | 30% | |
| 3* | 6.252 | 9.34 | 3.088 | 33% | 31.5% |

*Replicate

It is believed by the present inventors that the cannabinoid extracts forming the GREASE™ compositions, are bioavailable and assimilated into the growing plants, thereby activating the capitate-stalked glands of the glandular trichomes, where all cannabinoids are produced, to increase resin, which was reflected in the higher cannabinoid levels in the treated groups. Further, the availability of cannabinoid budding blocks thus supports the secretory section of the glandular trichomes. Therefore, the application of GREASE™ compositions to growing Cannabis plants provides cannabinoids in a form which become the building blocks for cannabinoid production, thereby generating an increase in the marketable portion of the crop.

II. Grease™ as a Soil Conditioner

Hydrophobicity of soil may be measured using a water drop penetration time (WPDT) test in accordance with standardized experiments taken from Carter, D. J. (2002) Water Repellence, in N. J. McKenzie et al. Soil Physical Measurement and Interpretation for Land Evaluation, CSIRO Publishing, Collingwood. The procedure was conducted at a 75° F. as follows: 25 to 30 g samples were taken out of the same sample of peat based soil (Biobizz Light-Mix) and placed on a horizontal surface. The samples were leveled and a 2-3 mm drop of water for the control, ethanol, and GREASE™ compositions (1 oz/gallon) soil treatments, was added to the surface of the soil. The time for the drop to infiltrate was recorded. The test was replicated 25 times and showed consistent results. Water repellency was classified according to TABLE 3. To ensure uniformity of sampling, water repellency was determined with the WDPT method on soil that was moist, air dried, and finally oven dried at 105° C. for about 6 hours.

TABLE 3

| | Time for Water | |
|---|---|---|
| Class | to Infiltrate (sec) | Description |
| 0 | 0-5 | not water repellent |
| 1 | 5-60 | slightly water repellent |
| 2 | 60-600 | moderately water repellent |
| 3 | 600-3600 | severely water repellent |
| 4 | [symbol] 3600 | extremely water repellent |

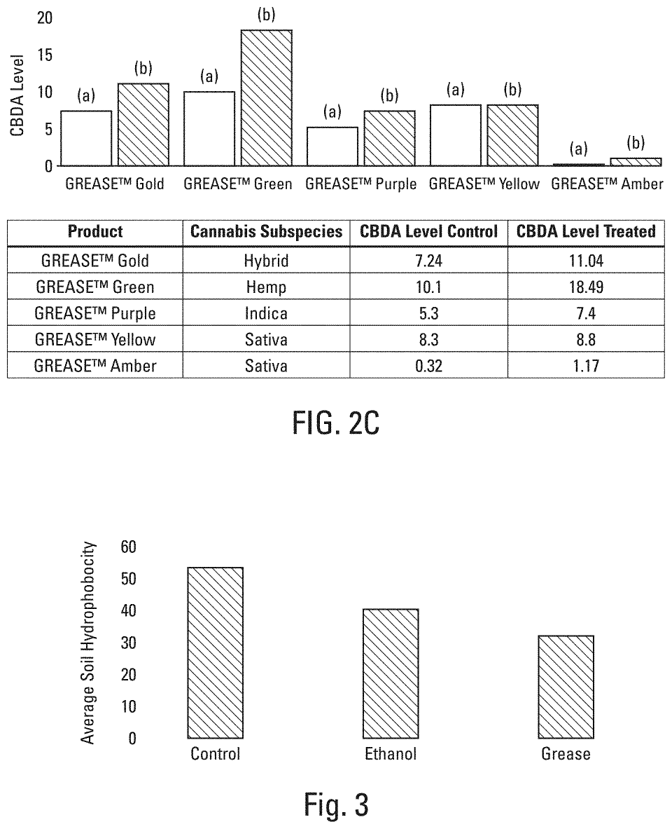

The average control soil infiltration time was 53.04 s, which is defined in TABLE 3 as a class 1 soil response of slightly water repellent. The average soil infiltration time after treatment GREASE™ compositions treatment was 32.52 s, which similarly identifies it as a class 1 repellency class with a soil response of slightly water repellent. All GREASE™ oils were found to affect the soil by making it less water repellent, thereby being a wetting agent, and breaking the surface tension of the soil. FIG. 3 shows that the average soil hydrophobicity of GREASE™ compositions as a drench improves the properties of the soil; that is, addition of cannabinoid extracts appears to chemically alter the soil. Additionally, despite being a non-polar compound, weak chemical bonding and interaction with soil aggregates is observed.

It is expected by the inventors that the cannabinoids, terpenes, and fats in the GREASE™ compositions are likely to be a significant source of food for other growing plants, when applied thereto and/or to the surrounding soil.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for increasing cannabinoid production in growing Cannabis plants, comprising:
extracting oil containing cannabinoids from Cannabis sativa hemp;
forming a solution of the extracted oil in a mixture of ethanol and water having a chosen concentration of the extracted oil; and
applying the solution to said growing Cannabis plants at chosen times during plant growth.

2. The method of claim 1, wherein said Cannabis plants comprise varieties chosen from hybrid, hemp, indica, and sativa.

3. The method of claim 1, further comprising the step of decarboxylating the extracted oil after said step of extracting oil containing cannabinoids, forming decarboxylated extracted oil.

4. The method of claim 3, wherein the extracted oil is chosen from decarboxylated extracted oil, and a mixture of decarboxylated extracted oil and extracted oil.

5. The method of claim 1, wherein said step of applying the solution to said growing Cannabis plants comprises foliar spraying at chosen times during plant growth.

6. The method of claim 1, wherein said step of applying the solution to said growing Cannabis plants comprises drenching soil surrounding said growing Cannabis plants at chosen times during plant growth.

7. The method of claim 1, wherein said step of applying the solution to said growing Cannabis plants comprises foliar spraying and drenching soil surrounding said growing Cannabis plants at chosen times during plant growth.

8. The method of claim 1, further comprising the step of drying the Cannabis sativa hemp before said step of extracting oil containing cannabinoids from the Cannabis sativa hemp.

9. The method of claim 8, wherein said step of extracting oil containing cannabinoids comprises contacting the Cannabis sativa hemp with liquid propane.

10. The method of claim 8, wherein said step of extracting oil containing cannabinoids comprises contacting the Cannabis sativa hemp with ethanol.

11. The method of claim 8, wherein said step of extracting oil containing cannabinoids comprises contacting the Cannabis sativa hemp with supercritical carbon dioxide.

12. A method for reducing the hydrophobicity of soil, comprising:
extracting oil containing cannabinoids from Cannabis sativa hemp;
forming a solution of the extracted oil in a mixture of ethanol and water having a chosen concentration of the extracted oil; and
applying the solution to said soil.

13. The method of claim 12, further comprising the step of decarboxylating the extracted oil, after said step of extracting oil containing cannabinoids, forming decarboxylated extracted oil.

14. The method of claim 13, wherein the extracted oil is chosen from decarboxylated extracted oil, and a mixture of decarboxylated extracted oil and extracted oil.

15. The method of claim 12, further comprising the step of drying the Cannabis sativa hemp before said step of extracting oil containing cannabinoids from the Cannabis sativa hemp.

16. The method of claim 15, wherein said step of extracting oil containing cannabinoids comprises contacting the Cannabis sativa hemp with liquid propane.

17. The method of claim 15, wherein said step of extracting oil containing cannabinoids comprises contacting the Cannabis sativa hemp with ethanol.

18. The method of claim 15, wherein said step of extracting oil containing cannabinoids comprises contacting the Cannabis sativa hemp with supercritical carbon dioxide.
